(19) United States
(12) Patent Application Publication
(10) Pub. No.: US 2003/0191770 A1
(43) Pub. Date: Oct. 9, 2003

(54) System and method for formatting, proofreading and annotating information to be printed in directories

(76) Inventors: Christopher S. Nudi, Raleigh, NC (US); Ricky A. Blue, Fuquay-Varina, NC (US); Lisa Swiger, Raleigh, NC (US); Robert J. Hoff, Wake Forest, NC (US); James K. Barton, Garner, NC (US); Sally E. Powell, Raleigh, NC (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/119,333

(22) Filed: Apr. 9, 2002

(51) Int. Cl. G06F 17/00

(52) U.S. Cl. 707/101

(57) ABSTRACT

A method and apparatus for formatting and annotating a directory data file is provided. The directory data file is formatted into an electronic file or files in order to permit a user to easily search and review the pages and/or items of interest to the user. In addition, the user reviewing the pages and/or items may provide comments or other instructions regarding corrections to be made to specific pages or entries on pages within the directory. Files formatted according to the invention may be accessed locally or remotely on a variety of different media.

### FIELD OF THE INVENTION

This invention relates generally to the field of information display and editing, and more particularly, to a method and system for formatting, proofreading, and annotating information that is intended to be printed in a directory, e.g., telephone, travel and industrial directories and the like, or displayed in an on-line or electronic directory.

### BACKGROUND OF THE INVENTION

The layout and printing of directory information, including telephone directories such as Yellow Pages directories, is a complex process. Among other things, the layout of pages within a directory includes complex decisions regarding the placement of information and advertisements. Directory publishers and their customers seek to avoid printing inaccurate information, particularly for those persons and entities that have paid to advertise within a given directory. Thus, in addition to laying out the directory, the publisher must verify the content of information within the directory. It is obvious that these steps must be taken prior to printing all or a significant number of the final version of the directory.

In many publication systems, the process of verifying page layout and content is accomplished by printing one or several proof copies and then reviewing, editing, and changing these page “proofs” as necessary to correct errors. This is an iterative process that usually results in several page proofs of the directory being printed. Such procedures are typically time-consuming and expensive.

The use of computers has simplified the process of publishing directories in many respects. Advertisements and telephone listings may be automatically laid out on computers according to certain rules and guidelines, including rules that relate to the pricing structure for advertisements. For example, larger advertisements, which are more expensive, are placed before smaller advertisements within a heading or section. Advertisements also must be on the pages for the headings to which the advertisement belongs or in reasonably close proximity. The telephone listings are typically organized in alphabetical order and may include small “in-column” advertisements. In addition, advertisements that appear closer to the heading in which they appear and to the top outer edges of the page are typically more desirable than those that are farther away.

Computers permit the layout and proofreading of directories to be simplified. Adjustments to the layout or copy may be made long before the final versions are printed. This is because the computer will display an accurate and faithful reproduction of how the final printed product is intended to appear. The page proofs may be reviewed by the publisher, the sales representative and the advertisers, either separately or together, for any errors or discrepancies.

The task of proofreading telephone directory advertisements typically falls on the sales agents and representatives that have “sold” the advertisement. Sales agents and representatives also may assist in the layout process. These agents may be employees of the publisher or they may be independent contractors. Any errors or discrepancies noted by the sales agents must be communicated to the publisher in order to insure that any appropriate changes to the advertisements, listings or other directory features are made before the directory is printed. For example, a sales agent may notice that a particular advertisement contains an incorrect phone number. The agent must then inform the appropriate people within the publishing organization that a correction must be made.

Often, however, the sales agents and/or advertisers are not located in the same geographical area where the pre-press production and/or printing will occur. In order for these agents and customers to access the page proofs of the directory, they must travel to the pre-press production facility, where the information is stored. In the alternative, the publisher must transmit to each agent a proof of the entire directory or, at least, the page proofs for those entries for which the agent is responsible. However, given the fact that a final layout may not be known until the time period immediately preceding the publication, and because the timing of printing and publication are crucial, this task of submitting and reviewing page proofs, even on a computer, becomes difficult.

In addition, the final page-proofing process must minimize disruption to the printing schedule. Large printing operations, such as those associated with printing directories, must be planned considerably in advance of the time when the printing actually takes place. Delays in the print schedule may result in substantial charges or additional costs for the publisher and/or print organization. It is important, therefore, that the final page-proof be conducted in an efficient manner. This is true regardless of the physical location of the sales agents, advertisers and/or printers.

Accordingly, there is a need for an improved method and system for allowing authorized sales agents and/or customers, who may be spread across different geographical locations from the pre-press production facility or printer, to access computer images of advertisements that are to be printed in a telephone directory. In addition, there is a need to present the page proofs of a directory in a simple to understand and intuitive format.

### SUMMARY OF THE INVENTION

In accordance with this need, the invention described herein presents a solution for easily formatting directory information in a manner that may be subsequently used in an electronic page review and/or printed page review. The electronic files generated by the present invention permit a timely and efficient review of page proofs of a directory, regardless of the actual physical locations of the directory's publisher, its sales agents, its customers or the final printing company. Any corrections or modifications to the directory that are necessitated as a result of the page review process may be subsequently implemented in a variety of ways. For example, it is possible to immediately and automatically update the directory. As another example, it is possible to accumulate several corrections or modifications in order to process all such changes in a batch manner. Directory information, which has been formatted in accordance with the system and method described herein, may be accessed in an on-line manner over the Internet, a wide-area network, a local-area network or even from a stand-alone computer.

In a preferred embodiment of the invention, the electronic display is controlled to maximize the display of the page proof and minimize the amount of scrolling that may be required by a user in order to review the page proof. Alternatively, the display may be controlled by a user-specific application, such as an Internet browser, which may control the total size of the display. In the latter alternative, it may be necessary to scroll the display in order to view the entire page proof. The browser may access the page proof over the Internet or a WAN, for example, through the use of appropriate thin-client software, such as that sold commercially by Citrix Systems, Inc.

Once the publisher converts a directory database from a proprietary application and/or file format into a more common file format, such as that used by Adobe® Acrobat® (“Acrobat”) and Adobe® Acrobat® Reader® (“Acrobat Reader”), both of which are produced by Adobe Systems Incorporated of San Jose, Calif. Once the directory information has been properly formatted according to the invention, any user with the appropriate software, such as Acrobat or Acrobat Reader, may view, access and/or search the directory.

An advantage of using page proofs that have been formatted as Portable Document Format (“PDF”) documents is that many sales agents and their customers will have preloaded either Acrobat and/or Acrobat Reader onto their computers. This is due to the high number of Internet and/or world-wide web sites that publish information in PDF form. It is noted, however, that the present invention is not limited to a particular file format or a particular software application for viewing the directory information. An alternative format from PDF is Scalable Vector Graphics (SVG). Details on SVG are available on the Internet at http://www.w3.org/TR/SVG.Once the directory information has been formatted in PDF, SVG, or other acceptable form, a publishing company's sales agents and clients may review or proofread preliminary pages, even at a geographically distant location from the actual pre-press production facility or printing facility, in order to correct mistakes prior to printing the directories. The use of this invention will increase the quality of directories and also increase the value of the directories to the publisher and its clients. The invention also saves the actual cost of travel to the publisher and the opportunity cost of time lost.

Additional features, advantages and objects of the invention will be made apparent from the following detailed description of illustrative embodiments which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram illustrating a exemplary display of a page proof from a Yellow-Pages type directory;

FIG. 2 is a block diagram illustrating an exemplary computer system on which the present invention resides or executes;

FIG. 3 is a block diagram illustrating one possible configuration of several networks of computers in order to present properly formatted directory information to the publisher and/or its sales agents and/or their respective customers;

FIG. 4 is a flow chart diagram illustrating one method for formatting directory information into PDF form;

FIGS. 5 through 17 are exemplary screen shots taken at various stages in the process of reformatting proprietary or other data into PDF form;

FIG. 18 is a screen shot of an exemplary home page for displaying multiple directories that are formatted in accordance with the present invention; and

FIGS. 19 through 26 are exemplary screen shots that illustrate the use of directory information that has been processed according to the present invention.

### DETAILED DESCRIPTION OF THE INVENTION

Turning to the drawings, wherein like reference numerals refer to like elements, the invention is illustrated as being implemented in a suitable computing environment. Those skilled in the art will appreciate that the invention may be practiced with other computer system configurations, multi-processor systems, microprocessor based or programmable consumer electronics, network PCs, minicomputers, mainframe computers, hand-held devices (PDAs) and the like. The invention also may be practiced in distributed computing environments where tasks are performed by remote processing devices that are linked through a communications network. In a distributed computing environment, program modules may be located in both local and remote memory storage devices. Appropriate thin-client software and/or multi-user operating systems, such as that offered by Citrix Systems, Inc., may be required to implement certain features of the invention in a distributed computing environment.

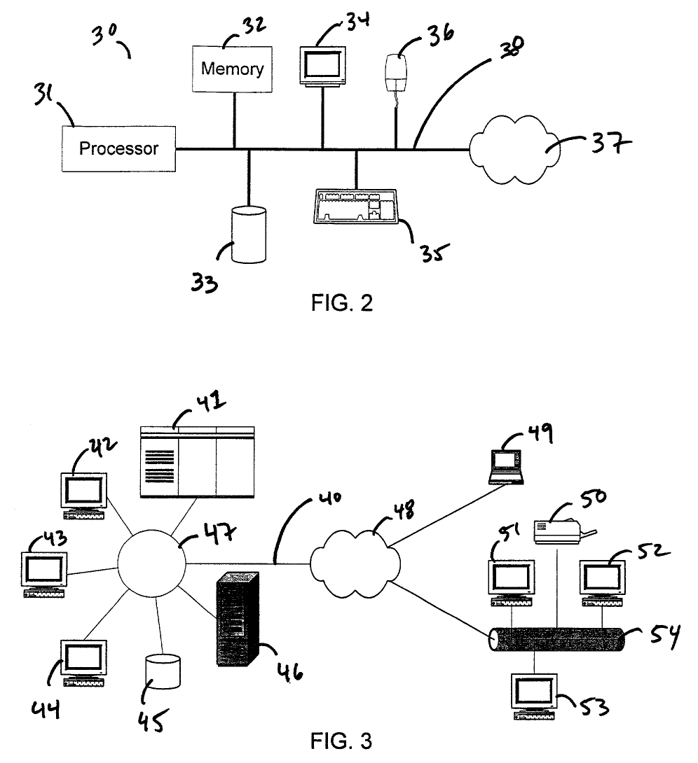

With reference to FIG. 2, and by way of example only, a representative system for implementing the invention includes a general purpose computing device 30 in the form of a conventional personal computer that include a processing unit 31, system memory 32, and a system bus 38 that couples various system components including the system memory to the processing unit 31. The system bus 38 may be any of several types of bus structures including a memory bus or memory controller, a peripheral bus, and a local bus using any of a variety of bus architectures. The system memory 32 includes read only memory (ROM) and random access memory (RAM). The personal computer 30 further includes storage mechanisms, generally illustrated as 33, which may include, for example, a hard disk drive, a magnetic disk drive, an optical disk drive (such as a CD ROM), magnetic cassettes, flash memory cards, digital video disks, and the like. The storage mechanisms are connected to the system bus 38.

A number of program modules may be stored in the system memory 32 or the storage mechanisms 33, including an operating system, one or more applications programs, other program modules, and program data. A user may enter commands and information into the personal computer 30 through input devices such as a keyboard 35 and a pointing device 36. Other input devices (not shown) may include a microphone, joystick, game pad, satellite dish, scanner, or the like. These and other input devices are often connected to the processing unit 31 through the system bus, but may be connected by other interfaces, such as a parallel port, game port or a universal serial bus (USB). A monitor 34 or other type of display device is also connected to the system bus 38 via an interface, such as a video adapter. In addition to the monitor, personal computers typically include other peripheral output devices, not shown, such as speakers and printers.

The personal computer 30 may operate in a stand-alone mode, with the properly formatted files being located on a hard disk drive or other suitable medium, such as a CD-ROM or ZIP disk, or in a networked environment. A network of computers is illustrated in FIG. 2 as cloud 37. This cloud represents any possible network, such as a local area network (LAN), a wide-area network (WAN), or the Internet. Such networking environments are commonplace in offices, enterprise-wide computer networks, intranets and the Internet.

FIG. 3 illustrates a representative computer network environment, particularly for a publishing concern. Numerous personal computers, as indicated by reference numerals 42-44, may be connected over a first network 47, that is illustrated in a token-ring configuration. Although a token-ring configuration is illustrated, it is noted that the actually configuration of the network is unimportant and that any suitable network configuration may be employed. A node on the network 41 represents the actual printing machines and supporting peripheral equipment. FIG. 3 represents this equipment in a schematic sense only. This node 41 will be understood by a person of skill to include all appropriate nodes and printing machines, from large offset web presses to smaller single sheet printers, in order to carry out a specific print run. In practice, the printing machines may include standard printing pre-press and press operations as well as technologically advanced printing operations, such as those used in computer-to-plate (C2P) or computer-to-press (CTP) systems. An example of a C2P system is disclosed in U.S. Pat. No. 5,738,014, which is hereby incorporated by reference. The printers and C2P or CTP systems need not be directly connected to the network upon which the pre-press page-review is conducted.

In addition, the network may include one or more server computers, illustrated as reference numeral 46, and data, illustrated as reference numeral 45. The data may include central databases that contain all of the directory information for one or more directories. The server computers 46, along with the personal computers 42-45 and data 45, typically includes proprietary software for causing directories or other information to be printed. According to well known electronic pre-press embodiments, images to be printed by offset printing means are assembled and edited electronically on a page layout workstation, such as any of the machines 41-44, or “front end”, and then transmitted to a raster image processor or other processor for separation, half-tone screening and image rasterization. The rasterized image to be printed by offset printing means is then transmitted to a laser imagesetter for photographic or film recording or C2P processing. All of the necessary pre-press and press data and applications are intended to be schematically represented in the first network 47. The first network 47 may be further connected to other networks. This is indicated schematically by reference numeral 40, which represents an interconnect between the first network 47 and a second network 48. As way of example only, the second network 48 may be the Internet. FIG. 3 further illustrates that remote users may directly connect to the first network through the second network 48. In the alternative, remote users may access the first network via a direct dial connection (not shown) or through a third network 54. This third network may contain yet additional personal computers 51-53 and peripheral equipment, such as a printer 50. Other network connections known to persons skilled in the art are also possible.

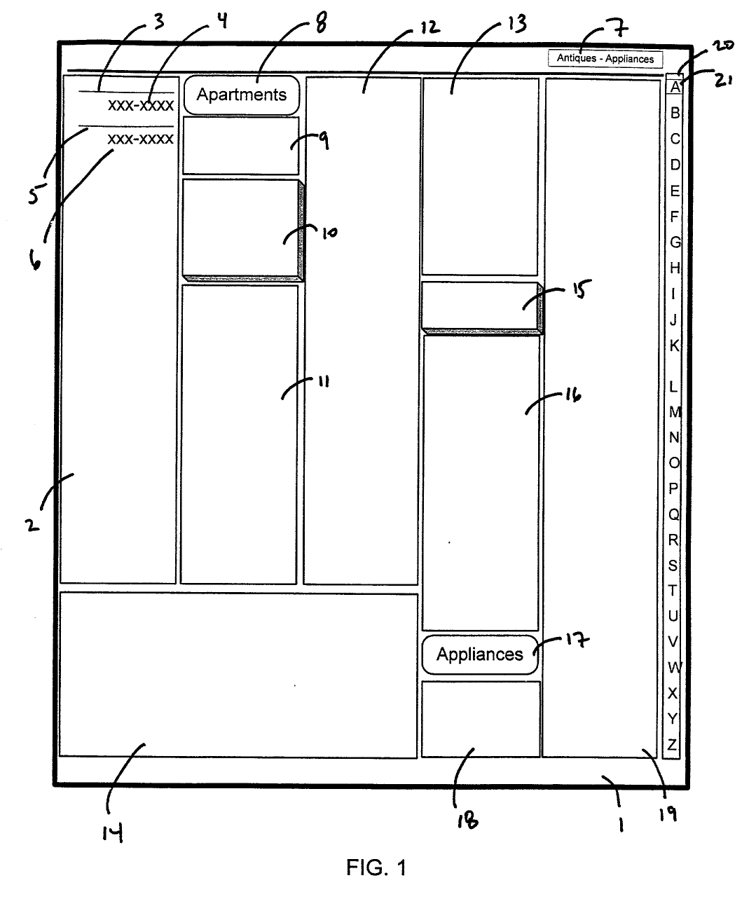

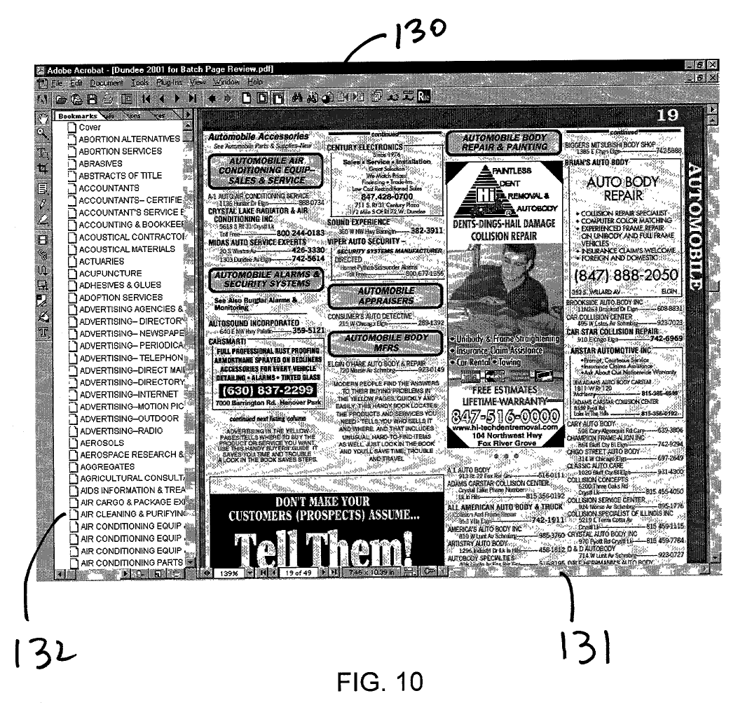

Publishing concerns may use computers and network environments, such as those illustrated in FIGS. 2 and 3, in order to format directories, such as those commonly referred to as Yellow Pages directories. FIG. 1 illustrates, in block diagram form, an example page that was produced by a typical front-end pre-press workstation. The page, as indicated by reference numeral 1, includes five columns of telephone listings. The rectangular block 2 represents several business listings, as do blocks 9, 11-13, 16, and 18-19. FIG. 10, which is a screen shot of a telephone directory page as displayed on a computer, more graphically indicates a representative page and the telephone listings. The representative page 1 also includes guide words 7, which are similar to those found within a dictionary. This example page may be an actual physical page or it may represent a computer display within a front-end workstation.

Each telephone listing on page 1 includes a business name or a person's name, which is shown as a line 3, and the telephone number, which is shown as a series of “x” letters 4. Of course, a business address or any other pertinent information may also be included in the entry identified by the “x” letters. Also, the entry may span either a single line as shown or several lines (not shown).The listings are organized in alphabetical form within each heading. The beginning of a new heading is indicated by a “heading bubble,” such as heading bubble 8 or heading bubble 17. The heading typically includes a name, e.g., heading bubble 8 includes the word “Apartments” and heading bubble 17 includes the word “Appliances.” Telephone listings that belong in the Apartments heading are placed in blocks 9 and 11 through 13. Listings that belong in the Appliances heading are placed in blocks 18 and 19.

The representative directory page also contains advertisements, which may be inserted in an “in-column” fashion or as larger stand-alone items. In-column advertisements, such as those indicated by reference numerals 10 and 15, are placed in the correct alphabetical order within the appropriate heading. Larger stand-alone advertisements, such as that indicated by reference numeral 14, ordinarily are placed in close proximity to the appropriate heading. As noted above, the layout of in-column advertisements, larger advertisements and telephone listings is a complex task.

Publishers of telephone directories either purchase proprietary software, design their software or use a combination of both in order to assist the process of laying out heading bubbles, listings, in-column advertisements, and Display advertisements. The software typically generates vector and raster-based PostScript (PS) or encapsulated-PostScript (EPS) files that may be used to effectuate the printing of directories on large volume printers. In the printing industry, the most commonly used file formats include PS, EPS and/or Tagged Image File Format (TIFF). Persons of ordinary skill in the art may use well-known techniques to generate one or more electronic files that have been properly formatted for use in printing a telephone directory.

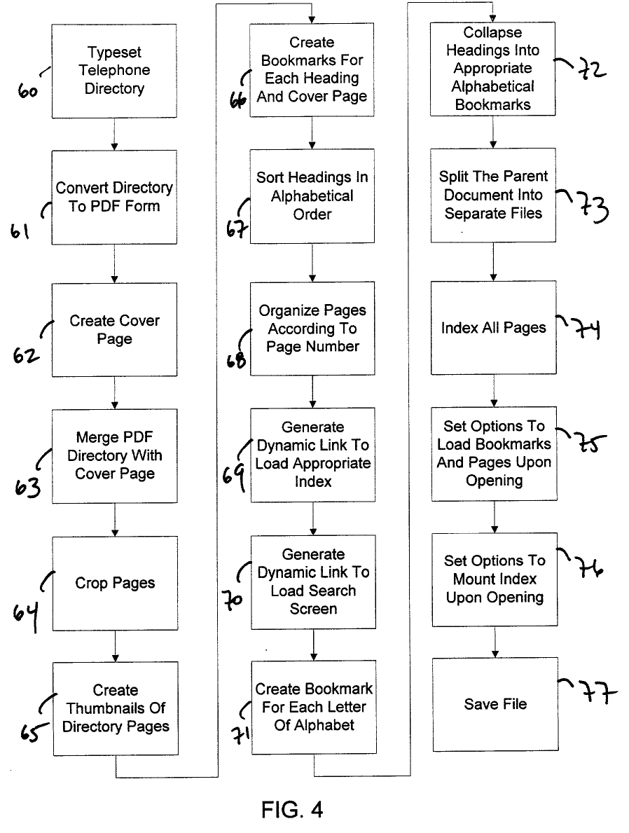

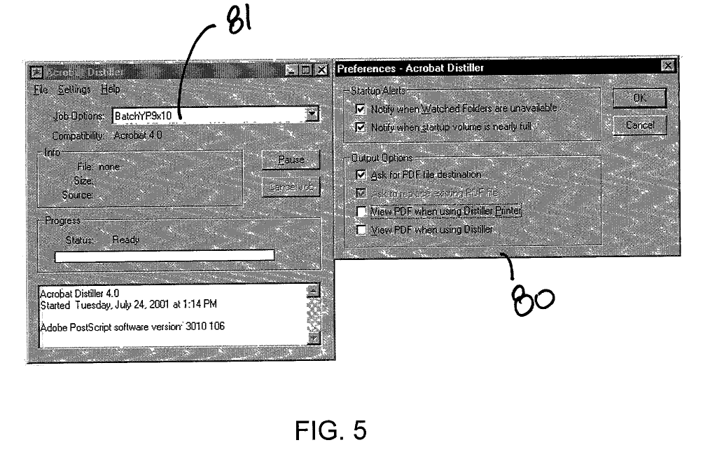

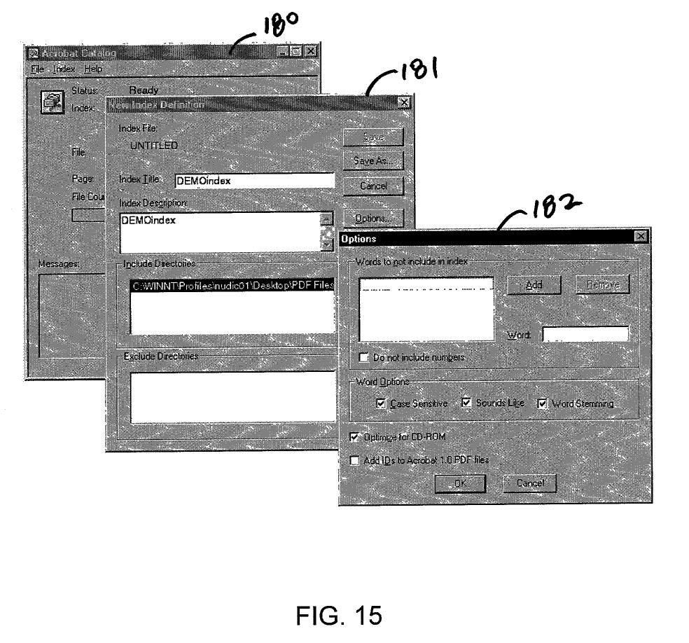

FIG. 4 is a flow chart of the process of converting an EPS file in accordance with one aspect of the invention. Other file types, such as TIFF files, may also be converted, but, in a preferred embodiment, such files would first be converted to EPS format. The process steps illustrated in the flowchart, when applied to such a file, result in a user-friendly collection of files that may be readily used by a sales agent and/or an advertiser to review page proofs for accuracy, layout and the like. The screen shots of FIGS. 5 through 17 specifically illustrate the process of converting a preexisting file to a user-friendly series of PDF files using Adobe® Acrobat®. In practice, a user who is familiar with the front-end process of the typesetting processes is likely to execute the steps indicated by the flowchart of FIG. 4. The end-users, such as sales agents and their respective customers, will most likely not be involved in the formatting process.

Although FIG. 4 illustrates certain steps that may be useful in creating a file in accordance with a preferrred embodiment of the invention, not all of the steps are required. FIG. 4 is meant to be illustrative only and should not be taken as limiting the scope of invention. Those of skill in the art will recognize that certain steps can be modified in arrangement and detail without departing from the spirit of the invention.

The first step in the process 60 is to typeset the directory. This step refers to any of the front-end design and layout procedures described above. In an electronic pre-press system, typesetting the directory results in the creation of a digital file. This file, as indicated by step 61, is then converted into PDF form. In a preferred embodiment, this step is performed by the Distiller module that is packaged with Acrobat but other PDF creation software could also be used. FIG. 5 is a screen shot of the Distiller module, an instance of which is generally indicated as reference numeral 80.

As is evident from FIG. 5, the Distiller module, once launched by the user, requests certain data. Most particularly, the Distiller module requests the specification of Job Options, as indicated by reference numeral 81. As is generally well-known to users of Acrobat, the job options should be set in a manner to optimize the graphical layout of the directory for subsequent printing. In the example of FIG. 5, the options have been set to accommodate a 9″ by 10.6″ directory, as indicated by the options statement “Batch YP9x10.” The job options, among other things, set the constraints used by Distiller in the creation of a PDF file. After the options have been appropriately set, the user will then run Distiller to convert the files from PS or EPS file format into a PDF file.

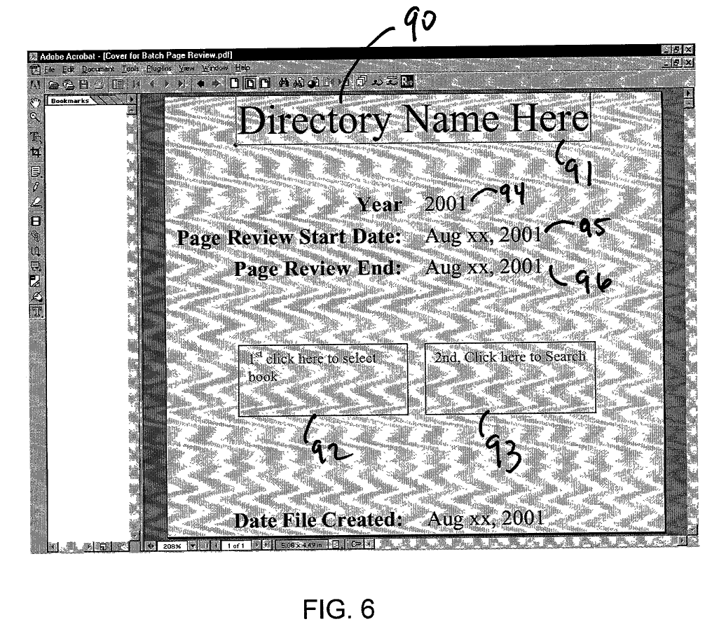

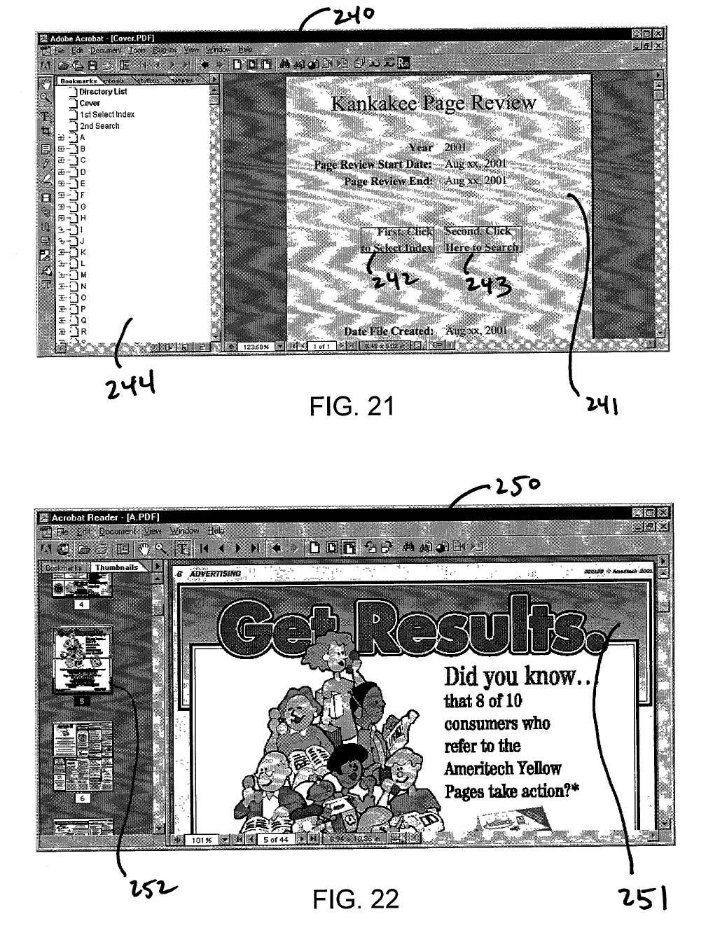

The PDF file created by the Distiller module will include images of the directory pages and other associated metadata. It will not, however, include any information that will assist a novice user to navigate through the directory. The next step of the process flow, step 62, is the creation of a cover page that will assist such a user to quickly and efficiently locate the information of interest. The cover page may be created by launching Acrobat and opening an existing template, such as that indicated by reference numeral 90 in the screen shot of FIG. 6. This template includes a data field for a directory name 91, a pair of hyperlinked icons 92, and date information 94-96. As described below, an example cover page is further illustrated in FIG. 21. The directory name should correspond to a particular printed directory, which usually covers a certain geographic area.

The cover page must then be merged, step 63, with the PDF files previously created in step 61. Acrobat permits the insertion of this file after or before the cover page. In a preferred embodiment, the cover page is inserted at the beginning of the new file.

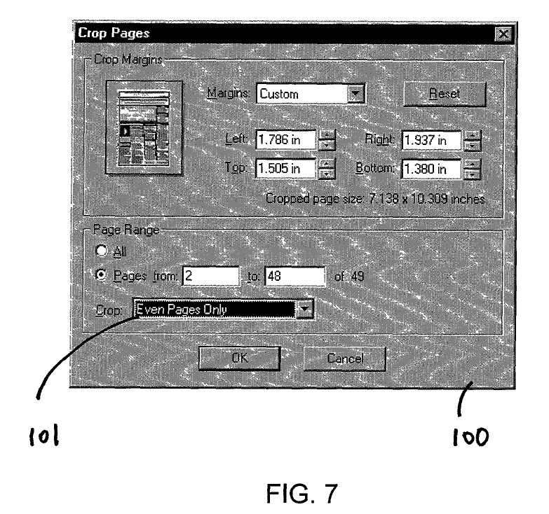

The PDF file created in step 61 and the cover page created in step 62 may not be optimized for viewing on a computer monitor. For example, the images may include a significant amount of space outside the printed area. This is due to the fact that a larger margin is required for the printing process than is required for display on a computer monitor. It is thus necessary to crop the pages in order to maximize the amount of information that may be displayed legibly on any given computer monitor. The step of cropping the image files for display on a monitor is indicated by step 64 in FIG. 4. FIG. 7 is a screen shot of Acrobat's Crop Pages dialog box 100.

The cropping step typically must be applied once for even-numbered pages and then again for the odd-numbered pages. The screen shot of FIG. 7, as indicated by reference numbral 101, shows that the cropping dialog box with the Even Pages Only option set. This step insures that the page under review, regardless of whether it is an even-numbered page or odd-numbered page, will be centered and displayed in an optimal location and at an optimal size.

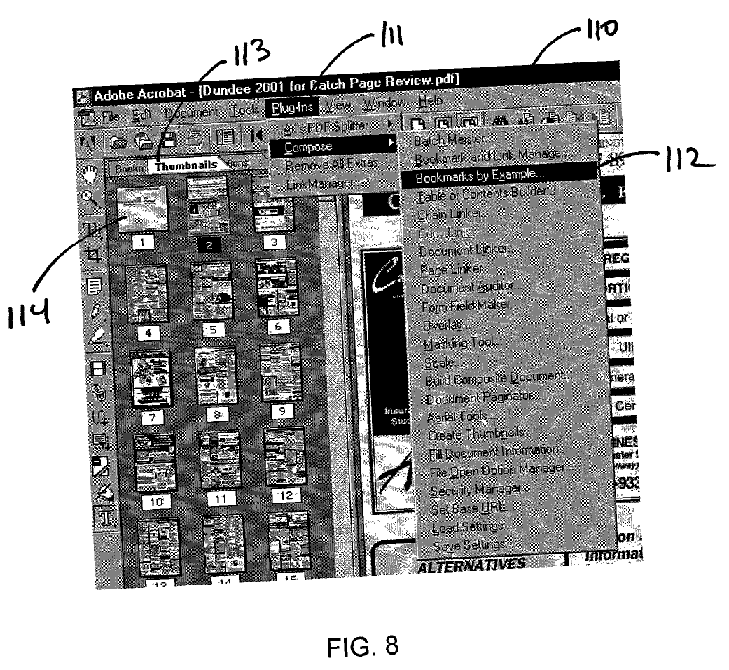

Once the cover page has been inserted and the pages have been appropriately cropped, “thumbnail” images of the on-line directory may be created. As is well-known, a thumbnail is a reduced-size version of the same image to be displayed. Thumbnail images, which are smaller in size and hence quicker to load, assist users to quickly navigate through long or complex documents. The step of creating thumbnail images of the directory is indicated by step 65 of the process flow illustrated in FIG. 4. FIG. 8 is a screen shot of a dialog box that illustrates several thumbnail images 114.

Next, as indicated by step 66 in FIG. 4, the user will create “bookmarks” for each heading within the directory. A bookmark is a pointer that specifies a particular location within a file or collection of files. Like thumbnails, an end-user may utilize bookmarks to quickly navigate through a long or complex document. In a preferred embodiment of the invention, each heading within the directory, such as the headings corresponding to “Apartments” or “Appliances” in FIG. 1, is indicated by bookmark. In addition, it is desirable to generate a bookmark for the cover page, which is included in the cover page template.

The step of generating bookmarks 66 preferably involves the use of a “plug-in” for the Acrobat program. Many computer programs which are commercially available today, such as Acrobat, enable other software developers to add functionality to such application programs, known as platform computer processes, by providing a plug-in interface. As is known to persons skilled in the art, a plug-in is a collection of computer instructions which is detected by a platform computer process at run-time and subsequently invoked during run-time. The platform computer process includes a mechanism by which separately provided plug-ins are detected and by which a user can invoke execution of any of the plug-ins.

As a result, a user can extend the functionality of the platform computer process by installing, and subsequently invoking execution of, various plug-ins. The user can thus customize the platform process to provide desired functionality while foregoing installation of plug-ins which provide functionality that is superfluous with respect to the particular needs of the user. In addition, software developers other than the developer of the platform process can develop and provide plug-ins to provide functionality which is not envisioned by developer of the platform process, thereby enhancing of the functionality ultimately provided by the platform process through addition of such plug-ins.

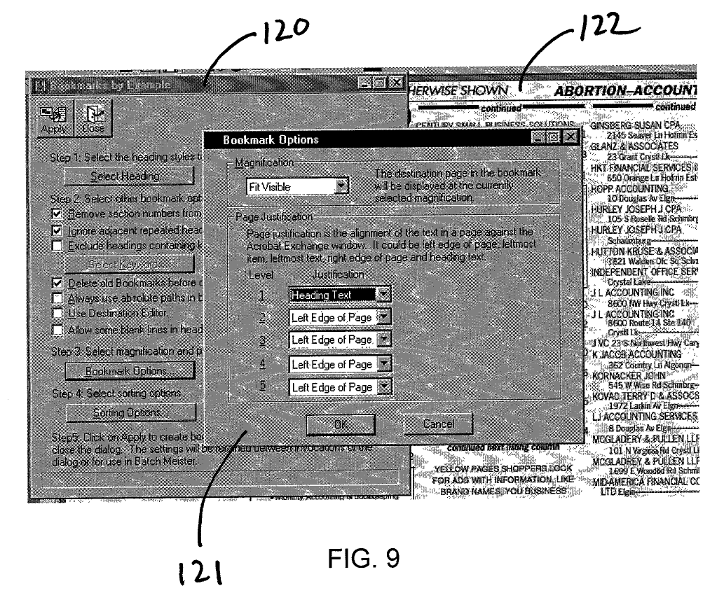

The creation of bookmarks within the electronic directory is an example of the use of a plug-in supported by Acrobat. As indicated by reference numeral 111 in the screen shot of FIG. 8, Acrobat includes a “Plug-Ins” option. In a preferred embodiment, a user executes the “Bookmarks by Example” plug-in. This module queries a user to highlight an example of the text that is to be used to create a bookmark. Subsequently, the module searches through the file to find similar instances to the example that a user highlighted. Each such located instance is then identified as a bookmark. The user also sets the options for displaying the located bookmarks. FIG. 9 is a screen shot 120 of the process for setting the bookmark options 121. The plug-in subsequently searches for all similar bookmarks. Although this plug-in simplifies the process of generating bookmarks, it is not required to implement the present invention. It is possible to individually designate each such bookmark and heading.

Subsequent to the creation of bookmarks for each heading and for the cover page, the next step in the process is to alphabetize the headings, as indicated by step 67 of FIG. 4, and then to organize the pages by page number, as indicated by step 68. This latter step insures that each page will be displayed in its appropriate order. FIG. 10 is a screen shot of an Acrobat window 130 that, in the left-side pane 132, includes all bookmarks arranged in alphabetical order by heading. The right-side pane 131 includes the full-sized, but cropped, image of the appropriate page in the directory.

The cover page of the electronic directory may then be set in order to simplify use of the directory for reviewing page proofs. Specifically, the cover page, which the user created in step 62, may include navigation buttons that are associated with a specific action. As illustrated in the screen shot of FIG. 6, a preferred embodiment of present invention includes two such navigation buttons: one button 92 is entitled “1st Select Index,” and the other button 93 is entitled “Search for Text.” The purpose of these navigation buttons is to simplify the steps that an end-user must undertake in order to efficiently use the formatted directory pages. Different navigations buttons and or navigation techniques that are known to persons of ordinary skill in the art may be substituted for the two buttons illustrated in FIG. 6 and described herein. The order in which the navigation buttons are established is of no particular significance, but, in the preferred embodiment, it is desirable for the user to perceive the appropriate sequence.

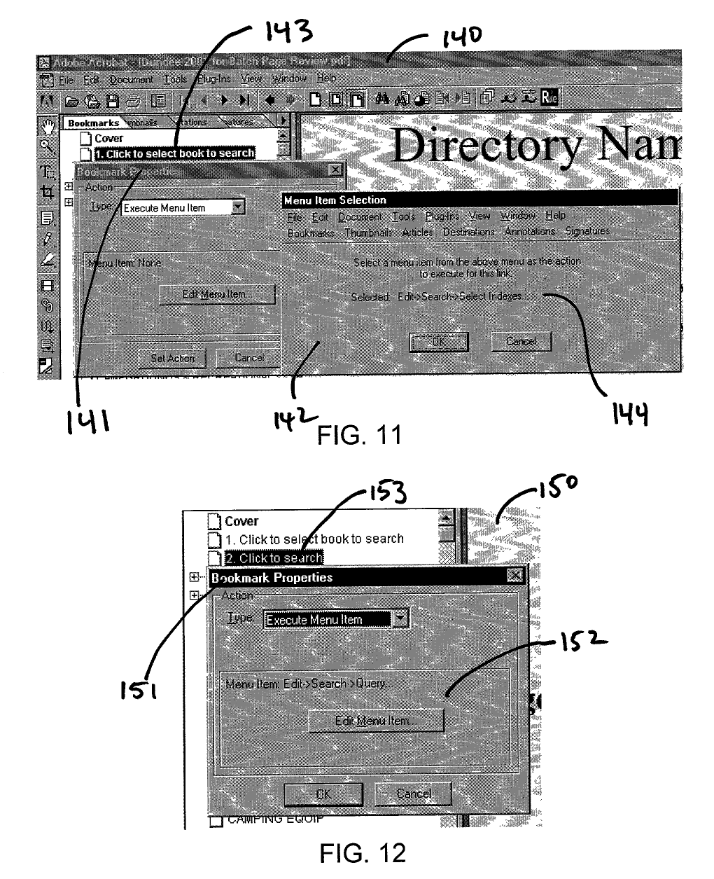

The navigation buttons may be established through the use of a built-in Acrobat feature. Specifically, Acrobat makes possible the association of an action with a particular bookmark within a document. This process is graphically illustrated in the screen shots of FIGS. 11 and 12. It is desirable that the end-user to be led through the process of selecting an appropriate index to search and then to begin searching that index.

In the process as illustrated in FIG. 4, step 69 specifies that a dynamic link be established with the sub-process of selecting an index. FIG. 11 is a screen shot of a dialog box 140 that may be used to set this action for the first navigation button 92. As indicated by reference numeral 144, the first navigation button 92 is set to launch the Select Index dialog box. FIG. 12, in turn, is a screen shot of a dialog box 150 that may be used to set a dynamic link with the sub-process of searching the index, i.e., step 70 of FIG. 4. The second navigation button 93 is thus appropriately set to launch the Select Query dialog box.

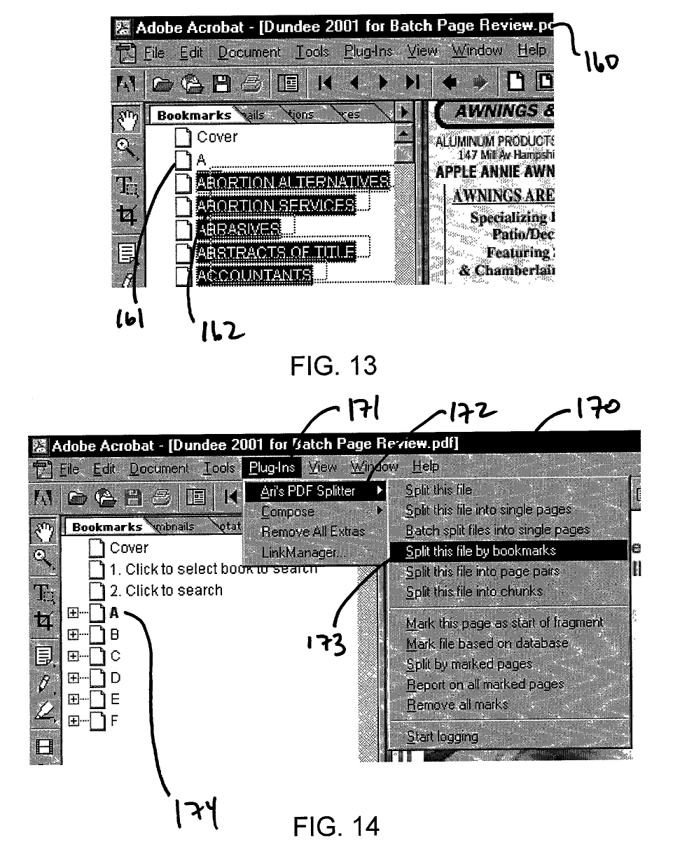

The next two steps of the process illustrated by FIG. 4 includes the creation of bookmarks for each letter of the alphabet 71, and the process of collapsing of each bookmark/heading into the appropriate letter of the alphabet 72. The latter step is illustrated in FIG. 13, which is a screen shot 160 of the process of collapsing certain headings—Abortion Alternatives, Abortion Services, Abrasives, etc., as indicated by reference numeral 162 into the bookmark/heading labeled “A,” as indicated by reference numeral 161, which may be created in accordance with the procedures described above. Each selected heading may be “dragged and dropped” into its appropriate letter. FIG. 14 is a screen shot that partially illustrates the alphabetical bookmarks 174 with headings that have been collapsed into the appropriate letters of the alphabet.

In one particularly advantageous implementation of the invention, the master file that contains all headings for a particular directory may be separated into individual files. For example, it may be desirable to split the alphabetical headings into twenty-six separate files, each representing a letter of the alphabet. This is advantageous because one user may make revisions to one file, e.g., the file for headings beginning with the letter C, while other users review and access the remainder of the files.

Acrobat does not provide a built-in feature to separate files in this manner. Thus, in the embodiment where Acrobat is used to format the directory, it is necessary to write or obtain a plug-in to accomplish this task. One such plug-in is known as a “Splitter,” and is available for purchase via the world-wide web at the following address: http://www.epublishstore.com under the trade name “ARTS.” This plug-in module splits a single PDF files into smaller PDF files and automatically adjusts and maintains links and bookmarks from the original document. FIG. 14 is a screen shot of the path used to launch the PDF Splitter. In one embodiment of the invention, the PDF Splitter is used to split the master file into twenty-seven individual files, one for each letter of the alphabet plus the cover page.

In an alternative embodiment, the master file is not split into separate files. In this embodiment, the invention uses a novel annotation system, described below, that does not require the master file to be locked in order for the user who is conducting a review to provide annotations, corrections or comments regarding certain items.

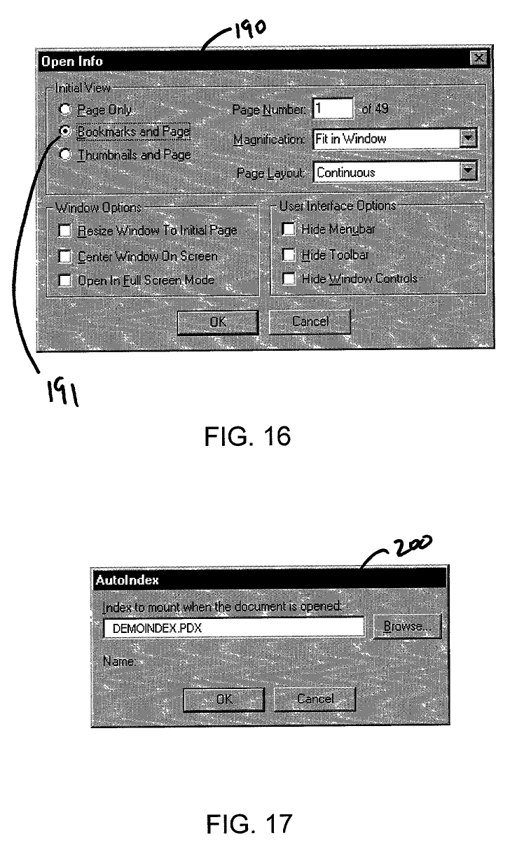

The final steps of the formatting process indicated by FIG. 4 include indexing the pages 74 and setting the appropriate options to display bookmarks 75 and mount the correct index 76 upon opening the properly formatted version of the directory. The final step is to save all relevant files 77. Acrobat has a built-in feature that performs the indexing step, as illustrated by a representative screen shot 180. In addition, as illustrated in FIGS. 16 and 17, Acrobat further includes tools that allow a user to specify the display of the directory once it is opened. To insure that the directory is user-friendly, it is generally advisable that the directory open with either the bookmarks and page displayed, as indicated by dialog box 190 of FIG. 16, or the thumbnails and page displayed (not shown). In addition, it is desirable upon opening a particular directory to pre-mount its corresponding index. This insures that a user may immediately begin use of the search feature built into the Acrobat application. Upon completion of these last steps, the directory is properly formatted and may be used for page proof reviews.

While the portion of the invention relating to formatting the directory has been primarily described herein as using Adobe Acrobat to create a PDF file, it will be appreciated by those of skill in the art that the invention is not intended to be so limited. Accordingly, the invention described herein contemplates more complex document models wherein the directory may be created, for example, by using web-page publishing tools or word processing program.

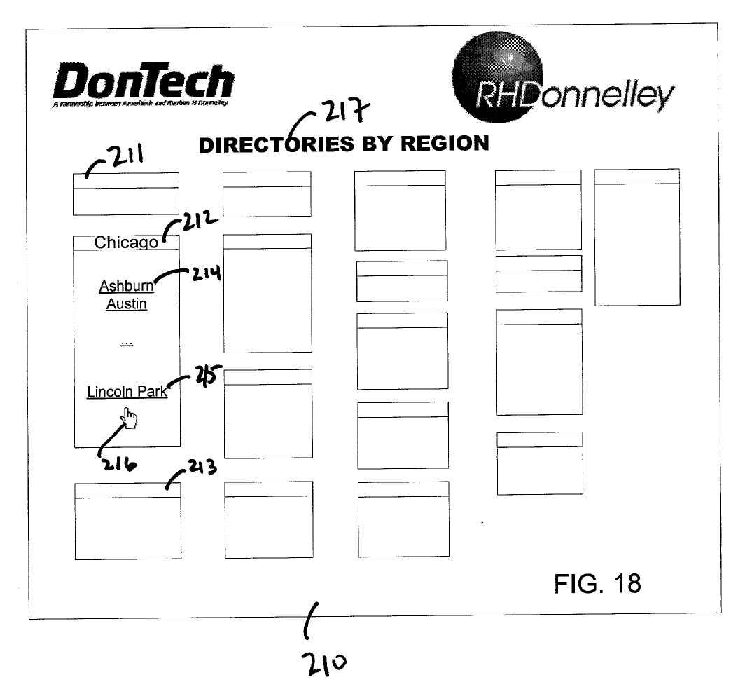

After each directory (or as many as desired) for a particular region has been formatted in accordance with the invention, it may be used by the end-users, such as sales agents and advertisers, for the purpose of reviewing page proofs. FIG. 18 is a block diagram illustration of a page, entitled “Directories By Region,” that collects numerous directories formatted in accordance with the present invention. Each rectangular block within FIG. 18, as indicated for example by reference numerals 211-213, represents a particular geographical region of an area that may have one or more telephone directories. Thus, the Chicago, Ill. (USA) region may include several directories, such as Ashburn 214 and Lincoln Park 215. This page 210 provides a convenient way of organizing all of the directories within a particular region.

Page 210 may be created in much the same manner as the cover page for an individual directory as described above. Each separate directory 214, 215 etc. represents a “link” that identifies a location on a file server, network, disk drive or CD-ROM. As described above, the bookmark is linked to a particular action. For purposes of page 210, each bookmark is set to open the cover page of a particular directory. Thus, an end-user that opens the regional directories page 210 will be provided with a variety of directories that he or she may begin to review by simply clicking with a mouse or other pointing device.

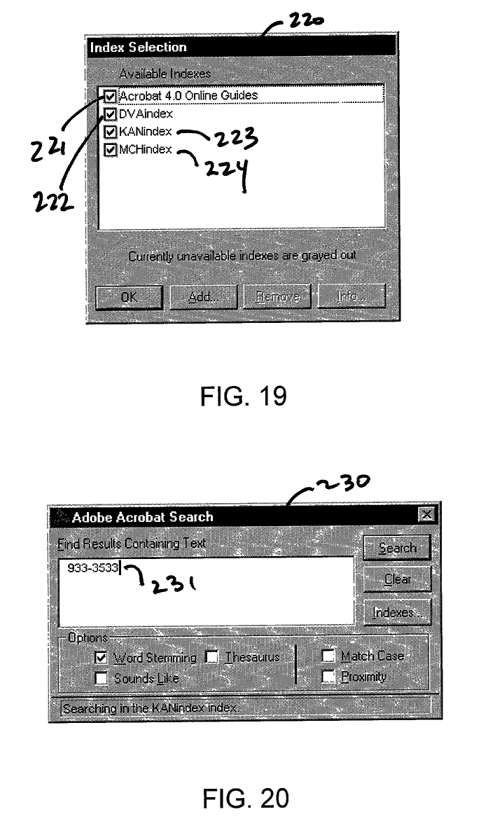

Upon opening a particular directory from page 210, the user will be presented with the cover page that was created in the formatting process. FIG. 21 is a screen shot 240 of a representative cover page 241. The cover page includes the navigation buttons 242 and 243 as well as the alphabetical bookmarks indicated in the left-side pane of the window 240. Upon clicking the “first” button 242, Acrobat opens a dialog box that prompts the user to select a particular index to search. FIG. 19 is a screen shot of a representative dialog box. Thereafter, the user may search all of the selected indices for a particular string of text, e.g., a telephone number or the name of a business or person. FIG. 20 is a screen shot of a representative dialog box in which a telephone number has been inserted. Upon clicking the Search button, Acrobat will initiate a search of the selected index for all occurrences of that telephone number.

As an alternative to searching the directory by using keywords, such as telephone numbers or business names, it is also possible to navigate the directory by using the thumbnails. For example, an end-user sales agent may know that his or her client's advertisement appears on a certain page of the directory. It is possible by using bookmarks and thumbnails to quickly navigate the directory to locate the appropriate page to review. FIG. 22 is a screen shot 250 that illustrates the use of thumbnails to locate a particular page.

Once the appropriate entry or advertisement has been located, the end-user must verify that the page proof contains accurate information. In one aspect of the invention, any errors or discrepancies are noted in a standard format that may be used by appropriate personnel within the publishing organization. This format makes use of the “annotation” tools of Acrobat. These tools provide a variety of methods for marking up text and attaching notes and commentaries to PDF documents. These annotations can be in text, graphic, movie, audio, or a link to another web site. The annotations and markups can be imported and exported from a PDF document.

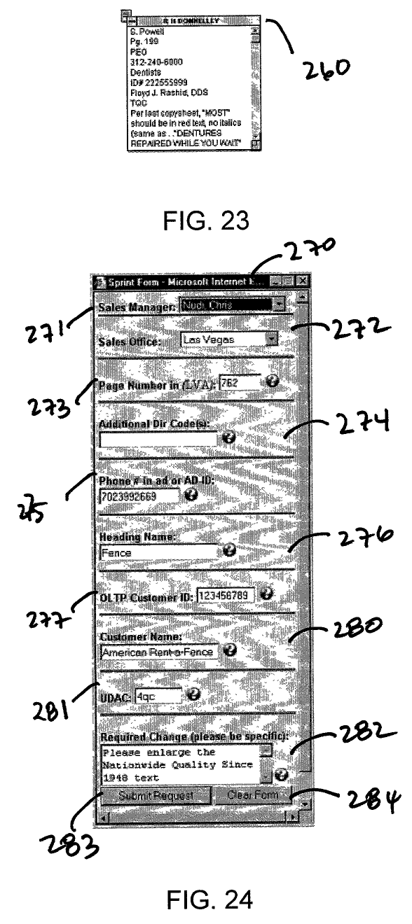

FIG. 23 is a screen shot of an annotation 260 that indicates a required correction to an entry. Preferably, the information included in each annotation follows a standard format. The information also should be sufficient for the publisher to quickly and efficiently make all require changes.

In an alternative embodiment, the annotation feature of Adobe Acrobat® is not used to provide information regarding required changes. Instead, a user may provide comments, annotations and required changes via an interface of the type shown in FIG. 24. This form is generated in HTML and may be operated via any appropriate browser, such as Internet Explorer. A user that seeks to provide a required change clicks on an appropriate link, which subsequently launches the browser and form.

The link to the browser and annotation form ordinarily is embedded in the file that has been converted from EPS format. Once the user locates an item requiring modification, the user clicks on the annotation link. Acrobat or Acrobat Reader then launches the appropriate annotation form. The user may then supply the necessary information to fill out the form or information may be retrieved from a central database. As an example, the form 270 includes a field 271 that indicates the manager responsible for the particular entry; a field 272 that indicates the originating sales office; a field 273 that indicates the page number in the appropriate directory; a field 274 for any additional directories to which the modification may apply; a field 275 for the telephone number of the entry or for another number that identifies the advertiser; a field 276 for the heading name; a field 277 that identifies the customer by number; a field 280 that indicates the customer's name; a field 281 that provides further advertisement size and color information of use to the publishing entity; and a field that indicates the precise nature of the required changes.

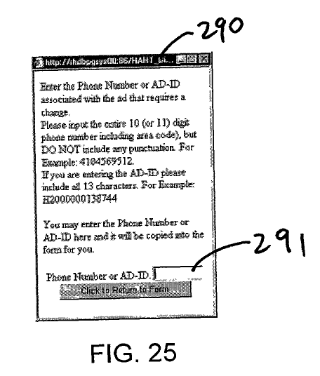

FIG. 25 is an example of a pop-up menu that assists the user in inputting information to the annotation form 270. This menu 290 may be automatically launched in conjunction with the annotation form or it may be launched in a separate step. In a preferred embodiment, the menu is launched simultaneously with the annotation form and it prompts the user to enter the proper telephone number for the directory item of interest, which corresponds to field 275 in FIG. 24. Once this field is filled out, the system of one preferred embodiment retrieves as much data as possible regarding the entry and appropriately fills in the annotation. For example, fields 271-273 and 276 through 281 may be automatically completed. The user subsequently completes the remainder of the form and/or modifies the entries that were automatically completed.

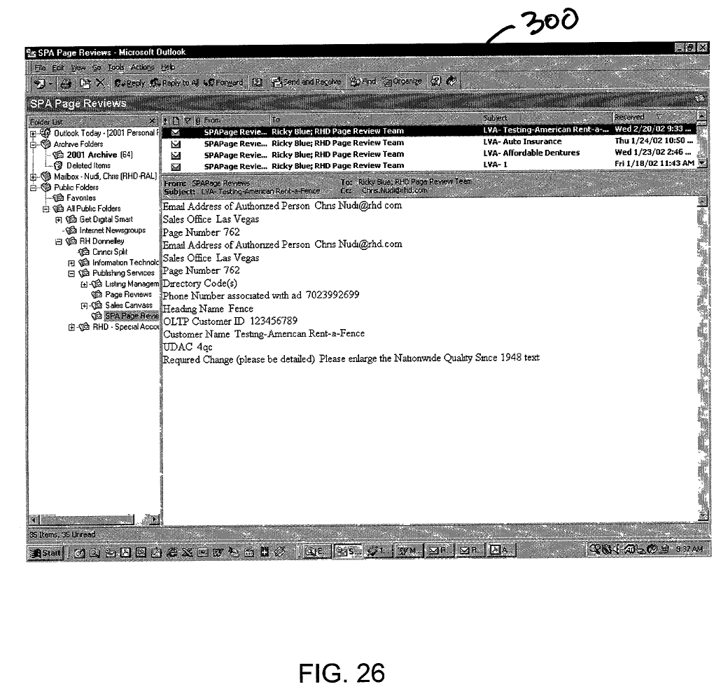

After the annotation form has been completed with all required fields, such as telephone number and required changes, the user “submits” the annotation by selecting the appropriate button 283. In this process, the data from the annotation form is converted into an email that is transmitted to the personnel of the publisher that are responsible for insuring that the changes are made to the directory as well as to the individual who submitted the requested change. FIG. 26 is an example email that corresponds to the data in the example annotation form of FIG. 24.

The annotation feature supported by the Adobe line of products, as illustrated in FIG. 23, requires read and write access to the underlying file. Thus, for optimum results, the underlying file must be selectively “locked,” i.e., only a single user may access the file at any given time. In contrast, the form method of supplying comments and/or required changes, as illustrated in FIG. 24, does not require a modification to the underlying file. Instead, a separate email is generated that sends the requested change instructions to the appropriate personnel. Thus, the properly-formatted directory file may be viewed by several users, each of whom may provide simultaneous comments on the content.

Regardless of the method of providing annotations and/or comments, however, the present invention provides a convenient and efficient method and apparatus for reviewing page proofs of a directory. Users may be located at a geographically distant locations from the pre-press production facility and/or the final printing location. In addition, the enhanced ability to search for, select and comment upon the items of interest to a user, whether a sales agent or customer, results in a faster and more efficient page review process.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

What is claimed is:

1. A method for electronically formatting and displaying directory information comprising the steps of:
generating a first computer-readable file of a telephone directory that is stored in a first file format;
converting the first file into a second computer-readable file of a telephone directory that is stored in a second file format;
generating thumbnail images of each page of the telephone directory that is to be printed;
generating a computer-searchable index of the second file, wherein the index includes names and telephone numbers of the entries to be published in the telephone directory;
generating a plurality of links that are associated with the second file and identify the locations of headings within the second file;
dividing said second file into at least two files and storing the at least two files in the second file format; and
displaying on a computer display a portion of a telephone directory with information obtained from one of the at least two files, wherein the portion of the telephone directory that is displayed is representative of a physical page of the telephone directory that is to be printed.

2. The method of claim 1 further comprising the step of logically associating data within the at least two files with a letter of the alphabet.

3. The method of claim 2 wherein the step of dividing said second file into at least two files further requires dividing said second file into twenty-six separate files, each of which includes the data that is logically associated with a letter of the alphabet.

4. The method of claim 1 further comprising the step of creating a cover page of the directory that may be used to automatically launch a search engine to search data contained within the index.

5. The method of claim 1 further comprising the step of creating a cover page that contains sufficient information to allow an operator to launch a search engine to search data contained within the at least two files.

6. A method for electronically proofreading a telephone directory that is to be printed comprising the steps of:
generating a computer-readable file of a telephone directory and storing the file on a data server;
establishing a connection between the personal computer and the server over a network;
searching an index for a specific entry in the telephone directory;
displaying an image on the personal computer by using information stored on the data server, wherein the image is representative of at least a portion of a telephone directory page that corresponds to the desired entry;
determining whether the specific entry is accurate; and
it the specific entry contains an inaccuracy, adding an annotation to the computer-readable file located on the data server while not changing any data previously stored in the computer-readable file.

7. A system for electronically proofreading a telephone directory that is to be printed comprising:
means for converting a telephone directory data file that may be printed into a computer file that may be displayed on a personal computer;
means for indexing the telephone directory data file;
means for displaying directories that have been formatted with the means for formatting;
means for selecting at least one of the displayed directories to proofread;
means for searching at least one index to be searched; and
means for annotating a particular entry within the displayable computer file with information that indicates any changes that must be made to that entry.

8. The system according to claim 7 wherein the telephone directory data file that may be printed is an Encapsulated Post-Script file.

9. The system according to claim 7 wherein the means for converting is the Distiller module of Adobe Acrobat.

10. A method for electronically previewing information and reporting errors comprising the steps of:
displaying on an electronic display an image of information that is to be printed in a directory;
reviewing the displayed image for any errors in the information;
displaying on the electronic display an electronic form that contains a plurality of predetermined fields for entering data relating to any errors in the information, wherein said portions of said form and said image are simultaneously visible on said display;
determining a list of people to whom the error data should be reported; and
electronically transmitting a message to the list of people, said message including the data relating to any errors.
